(19) United States
(12) Patent Application Publication
(10) Pub. No.: US 2016/0124517 A1
(43) Pub. Date: May 5, 2016

(54) KEYBOARD CONTROL SYSTEMS AND METHODS

(71) Applicant: LENOVO (SINGAPORE) PTE. LTD., New Tech Park (SG)

(72) Inventors: Markus Takashi Heberlein, Tokyo (JP); Mamoru Okada, Kanagawa-ken (JP)

(21) Appl. No.: 14/527,030

(22) Filed: Oct. 29, 2014

(51) Int. Cl. G06F 3/023

(52) U.S. Cl. CPC G06F 3/023

(57) ABSTRACT

Systems and methods are provided for analyzing key compression patterns on a keyboard using one or more computer servers and storage devices. In general, the systems and methods can include a computer system that keeps track of input from a keyboard over time and analyzes the resulting key compression patterns to determine whether the patterns satisfy predetermined criteria for activating one or more keyboard functions. The criteria can be defined to accommodate user error or inability to create a desired key compression pattern. In an exemplary embodiment, the computer system waits for a specified amount of time after receiving the keyboard input before activating certain keyboard functions. In this way, where a user accidentally waits too long before pressing a desired key, or where a user is not capable of pressing keys quickly, the computer system can still ascertain a user's intent to create a particular key compression pattern.

### FIELD OF THE INVENTION

Systems and methods are disclosed herein that generally relate to activation of different computer functions based on key compression patterns, and in particular to activation of a sticky key function or a “Caps Lock” function based on compression patterns of the SHIFT key.

### BACKGROUND OF THE INVENTION

For telephones and other mobile electronics that cannot accommodate a full keyboard, it has become customary for a single key to serve multiple functions. Traditionally, different functions can be accessed depending on the number of times a key is pressed in a given time frame, or depending on other keys that are pressed in conjunction with a given key during the time frame. For example, on many mobile phone keyboards, pressing the SHIFT key once will cause any letter key pressed while the SHIFT key is still compressed to appear as a capital letter, but pressing the SHIFT key quickly twice in a row activates the “Caps-Lock” function, causing every letter key pressed thereafter to appear as a capital letter until the Caps-Lock function is disabled.

Users become accustomed to using such key compression patterns for particular mobile devices, and expect that the same patterns will produce the same effect on any mobile device. However, as various manufacturers have created different key compression patterns, it is not always possible for a single keyboard to be able to respond appropriately to all of the patterns. Particularly where the patterns become more complex, the logic for determining which pattern a user was trying to create becomes similarly complex. These problems are exacerbated by the ever-increasing demand for more compact devices with fewer keys.

Using the SHIFT key as an example, many WINDOWS operating systems are programmed such that five consecutive presses of the SHIFT key will cause the computer to prompt a user about whether they would like to activate a “sticky keys” function. The sticky keys function is an accessibility requirement for people who have difficulty pressing multiple keys at once. Once activated, it allows keys like SHIFT, CONTROL, and ALT to remain virtually pressed until a subsequent key is pressed. However, this conflicts with the aforementioned convention among mobile device keyboards that two presses of the shift key results in activation of the Caps-Lock function. On a keyboard recognizing both patterns, for example, pressing the SHIFT key twice would automatically activate Caps-Lock, and a user would never be able to get to the sticky keys dialogue.

Therefore, a need exists for improved keyboard control systems and methods that can analyze key compression patterns.

### SUMMARY OF THE INVENTION

A method is provided that in one embodiment includes retrieving, by at least one computer processor, a key compression pattern and determining, also by the at least one computer processor, whether the key compression pattern includes five consecutive presses of a key. The key compression pattern can include identities of one or more keys that have been pressed by a user and time intervals between each key press and a previous key release. If the at least one computer processor determines that the key compression pattern includes five consecutive presses of the key, the method can further include sending a first signal immediately after the fifth release of the key. If the at least one computer processor determines that the key compression pattern does not include five consecutive presses of the key, the method can further include waiting for a timeout period before determining whether to send a second signal.

In another aspect, a method is provided that can include, for a plurality of keyboard functions, storing one or more criteria in a data store for activating the keyboard function. The one or more criteria can be met by at least two different key compression patterns. The method can further include, after a release of a final key in an input key compression pattern, retrieving the input key compression pattern by at least one computer processor and sequentially determining whether the input key compression pattern meets the one or more criteria for each of the plurality of keyboard functions in turn. Between at least two of the sequential determinations, the method can include waiting for a timeout period.

In yet another aspect, a method is provided that include retrieving, by at least one computer processor, a key compression pattern and determining, also by the at least one computer processor, whether they key compression pattern meets one or more criteria for activating a first keyboard function. The key compression pattern can include identities of one or more keys that have been pressed by a user and time intervals each key press and a previous release. If the at least one computer processor determines that the key compression pattern meets the one or more criteria for activating the first keyboard function, the method can further include prompting the user on a computer display about activating the first keyboard function. If the at least one computer processor determines that the key compression pattern does not meet the one or more criteria for activating the first keyboard function, the method can further include waiting for a timeout period before determining whether the key compression pattern meets one or more criteria for activating a second keyboard function.

In yet another aspect, a computer system is provided that can include a keyboard having a plurality of keys, a memory configured to store one or more criteria for activating each of a plurality of functions of the keyboard, and at least one computer processor configured to sequentially determine whether an input key compression pattern meets the one or more criteria for each of the plurality of keyboard functions in turn and, between at least two of the sequential determinations, to wait for a timeout period. The one or more criteria can be met by at least two different key compression patterns.

In yet another aspect, a non-transitory computer-readable storage medium containing instructions is provided. The instructions can cause one or more computer processors to retrieve a key compression pattern that includes identities of one or more keys that have been pressed by a user and time intervals between each key press and a previous key release. The instructions can further cause the one or more computer processors to determine whether the key compression pattern includes five consecutive presses of a key. If the one or more computer processors determine that the key compression pattern includes five consecutive presses of the key, the instructions cause the one or more computer processors to send a first signal immediately after the fifth release of the key. If the one or more computer processors determine that the key compression pattern does not include five consecutive presses of the key, the instructions cause the one or more computer processors to wait for a timeout period before determining whether to send a second signal.

### BRIEF DESCRIPTION OF THE DRAWINGS

The invention will be more fully understood from the following detailed description taken in conjunction with the accompanying drawings, in which:

FIG. 1 is a schematic diagram of one exemplary embodiment of a computer system architecture for carrying out the invention;

FIG. 2 is an exemplary embodiment of a computer system for carrying out the invention;

FIG. 3 is a flow chart that schematically depicts an exemplary method for activating computer functions based on key compression patterns;

FIG. 4 is a flow chart that schematically depicts an exemplary step of the method of FIG. 3;

FIG. 5 is a schematic representation of a key compression pattern;

FIG. 6 is a schematic representation of another key compression pattern;

FIG. 7 is a schematic representation of another key compression pattern;

FIG. 8 is a schematic representation of another key compression pattern;

FIG. 9 is a schematic representation of another key compression pattern;

FIG. 10 is a schematic representation of another key compression pattern;

FIG. 11 is a flow chart that schematically depicts another exemplary step of the method of FIG. 3;

FIG. 12 is a schematic representation of another key compression pattern; and

FIG. 13 schematic representation of another key compression pattern.

### DETAILED DESCRIPTION OF THE INVENTION

Systems and methods are provided for analyzing key compression patterns on a keyboard using one or more computer servers and storage devices. In general, the systems and methods can include a computer system that keeps track of input from a keyboard over time and analyzes the resulting key compression patterns to determine whether the patterns satisfy predetermined criteria for sending one or more signals to activate a computer function. The criteria can be defined to accommodate user error and/or inability to create a desired key compression pattern. In an exemplary embodiment, the computer system waits for a specified amount of time after receiving the keyboard input before sending certain signals. In this way, where a user accidentally waits too long before pressing a desired key, or where a user is not capable of pressing keys quickly, the computer system can still ascertain a user's intent to create a particular key compression pattern. The systems and methods disclosed herein are particularly useful with key compression patterns that involve multiple compressions of the same key, for example using multiple consecutive presses of the SHIFT key for sending a signal to active the Caps Lock or the sticky keys function.

Certain exemplary embodiments will now be described to provide an overall understanding of the principles of the structure, function, manufacture, and use of the devices and methods disclosed herein. One or more examples of these embodiments are illustrated in the accompanying drawings. Those of ordinary skill in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

In the present disclosure, like-named components of the embodiments generally have similar features, and thus within a particular embodiment, each feature of each like-named component is not necessarily fully elaborated upon. Sizes and shapes of devices and components of electronic devices discussed herein can depend at least on the electronic devices in which the devices and components will be used and the invention described herein is not limited to any specific size or dimensions.

### Computer Processor

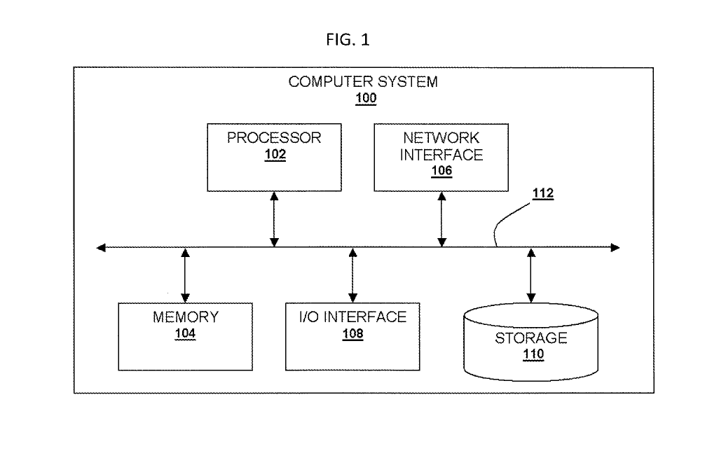

The systems and methods disclosed herein can be implemented using one or more computer systems, such as the exemplary embodiment of a computer system 100 shown in FIG. 1. As shown, the computer system 100 can include one or more processors 102 which can control the operation of the computer system 100. The processor(s) 102 can include any type of microprocessor or central processing unit (CPU), including programmable general-purpose or special-purpose microprocessors and/or any one of a variety of proprietary or commercially available single or multi-processor systems. The computer system 100 can also include one or more memories 104, which can provide temporary storage for code to be executed by the processor(s) 102 or for data acquired from one or more users, storage devices, and/or databases. The memory 104 can include read-only memory (ROM), flash memory, one or more varieties of random access memory (RAM) (e.g., static RAM (SRAM), dynamic RAM (DRAM), or synchronous DRAM (SDRAM)), and/or a combination of memory technologies.

The various elements of the computer system 100 can be coupled to a bus system 112. The illustrated bus system 112 is an abstraction that represents any one or more separate physical busses, communication lines/interfaces, and/or multi-drop or point-to-point connections, connected by appropriate bridges, adapters, and/or controllers. The computer system 100 can also include one or more network interface(s) 106, one or more input/output (IO) interface(s) 108, and one or more storage device(s) 110.

The network interface(s) 106 can enable the computer system 100 to communicate with remote devices (e.g., other computer systems) over a network, and can be, for example, remote desktop connection interfaces, Ethernet adapters, and/or other local area network (LAN) adapters. The IO interface(s) 108 can include one or more interface components to connect the computer system 100 with other electronic equipment. For example, the IO interface(s) 108 can include high speed data ports, such as USB ports, 1394 ports, etc. Additionally, the computer system 100 can be accessible to a human user, and thus the IO interface(s) 108 can include displays, speakers, keyboards, pointing devices, and/or various other video, audio, or alphanumeric interfaces. The storage device(s) 110 can include any conventional medium for storing data in a non-volatile and/or non-transient manner. The storage device(s) 110 can thus hold data and/or instructions in a persistent state (i.e., the value is retained despite interruption of power to the computer system 100). The storage device(s) 110 can include one or more hard disk drives, flash drives, USB drives, optical drives, various media cards, and/or any combination thereof and can be directly connected to the computer system 100 or remotely connected thereto, such as over a network.

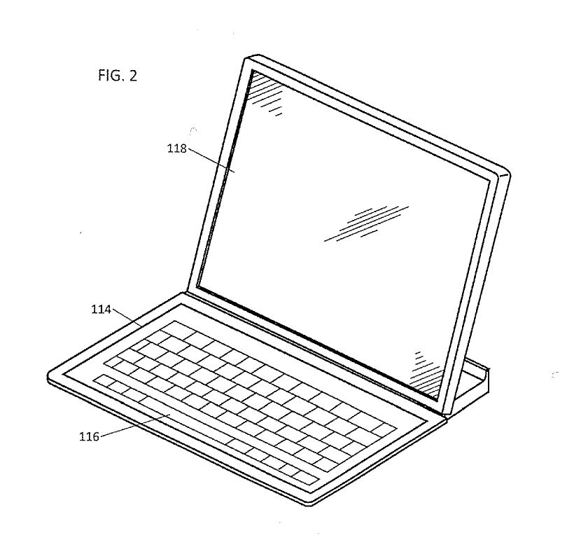

The elements illustrated in FIG. 1 can be some or all of the elements of a single physical device, e.g., a conventional desktop computer, workstation, minicomputer, laptop computer, tablet computers, PDAs, mobile phones, remote keyboard modules, and the like. In addition, not all of the illustrated elements need to be located on or in the same physical or logical machine. For example, some elements of the computer system 100 used to carry out the present invention can be located in a remote keyboard, while some are located in a tablet computer operatively coupled to the keyboard. In a preferred embodiment, the systems and methods of the present invention executed by the computer system 100 are housed in a remote keyboard 114 that is configured for use with a computer and/or a tablet computer 118. As shown in FIG. 2, the keyboard 114 can include a plurality of depressible plastic keys 116, but it will be appreciated by a person skilled in the art that the keyboard 114 can have any number of touch-based entry elements or could be implemented on a touch screen. The keyboard 114 can be wirelessly coupled to a second computer system in the tablet computer 118. In some embodiments, the keyboard 114 optionally can be configured for wireless connections to the tablet computer 118, such as Bluetooth or WiFi connection.

Although an exemplary computer system is depicted and described herein, it will be appreciated that this is for sake of generality and convenience. In other embodiments, the computer system may differ in architecture and operation from that shown and described here.

### Methodology

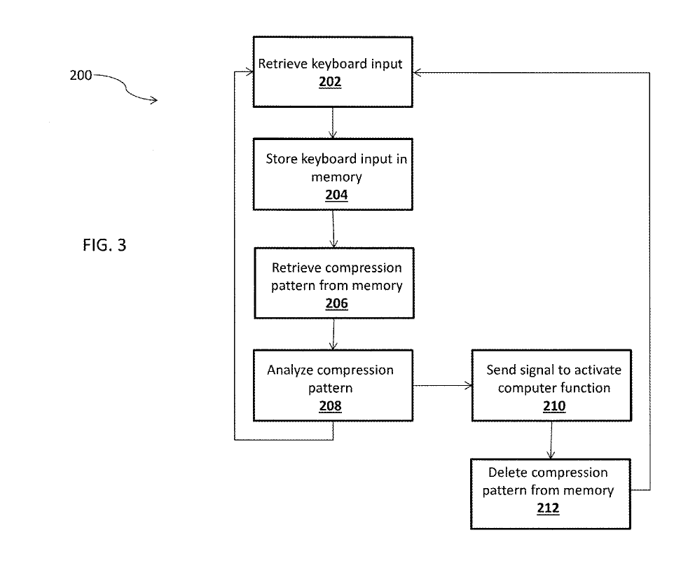

An exemplary compression pattern analysis method 200 executed by the computer system 100 is illustrated in FIG. 3. It will be appreciated that the method can be implemented in hardware, software, or a combination thereof. It will further be appreciated that, when implemented in software, the method can be part of a single program or one or more separate programs, and can be implemented in a variety of contexts (e.g., as part of an operating system, a device driver, a standalone application, and/or combinations thereof). In addition, software embodying one or more methods is not a signal and can be stored as an executable program on one or more non-transitory computer-readable storage mediums. Functions disclosed herein as being performed by a particular component of the computer system 100 can also be performed by any other component or combination of components.

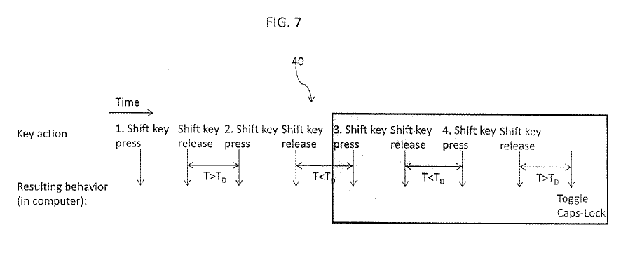

A first step 202 of the exemplary method 200 is to receive input from a keyboard, e.g., the keyboard 114, when a key is pressed. The input can include identification information of the key that was pressed as well as a time between compression of that key and release of the previous key. For example, the input can indicate that the “A” key was pressed 0.5 seconds after the SHIFT key was released. The processor 102 can then store the input information in a memory, for example in the short-term memory 104, as part of a key compression pattern. Exemplary key compression patterns, which will be explained in detail later, are illustrated in FIGS. 7-10 and 12-13. The processor 102 can then retrieve the entire compression pattern, including all keys pressed and a time interval between each compression, for analysis (step 206).

The analysis, explained in detail below, generally includes determining whether a key compression pattern meets criteria for activating one or more computer functions. In some embodiments, the criteria can be set to include both situations where the user actually created the “correct” key compression pattern and situations where the user failed to achieve the correct compression pattern, but likely intended to. Whether the user intended—but failed—to create the “correct” compression pattern can be based on assumptions about the user's intent and ability to create a given key compression pattern. The assumptions, as well as the criteria, can be stored in the storage 110 of the keyboard 114; however, they can be altered at any time, and can vary depending on the particular key compression pattern. If the processor 102 determines that a given key compression pattern does meet the specified criteria, it sends a signal to activate the computer function associated with the criteria. Otherwise, the processor 102 waits for the next keyboard input. In some embodiments, particularly where the computer function is intended to be a permanent or semi-permanent state, the key compression pattern is deleted from the memory 104 once the signal has been sent to activate the function. This is based on the assumption that whatever the user was intending to accomplish has been accomplished.

Various embodiments of the pattern analysis step 208 are explained below. For the sake of illustration, each of the exemplary analyses is related to consecutive compressions of the SHIFT key for activating the Caps-Lock or sticky key functions described above. The analyses are all based on the assumption that two consecutive, fast presses of the SHIFT key are intended to activate the Caps-Lock function, and five consecutive presses of the SHIFT key are intended to activate the sticky keys function. However, it will be appreciated by a person of skill in the art that similar methods can be used for many complex key compression patterns for activating any computer function. Also, although the methods are described below as being performed by an exemplary computer system 100 contained within the keyboard 114, they can be implemented by any one or more computer systems housed in any electronic device.

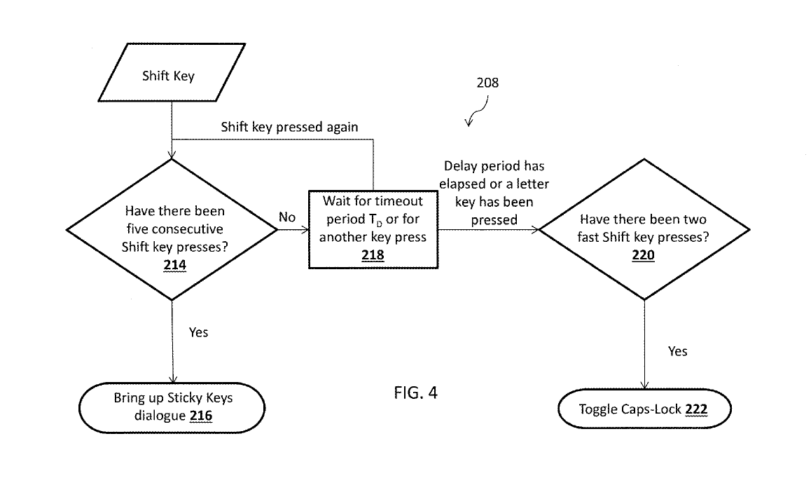

A first embodiment of a method 208 for analyzing key compression patterns is illustrated in FIG. 4 and is triggered when a user compresses and releases the SHIFT key. After the SHIFT key is released, the processor 102 determines whether the key compression pattern stored in the memory 104 includes five consecutive SHIFT key presses (step 214). If so, the processor 102 causes a computer display to bring up a dialogue box asking the user whether they want to activate the sticky keys function (step 216). If not, the processor waits for a timeout period T_{D} or for another key to be pressed. The timeout period T_{D} reflects a typical amount of time that it takes the average user to compress a key twice in a row. Due to variations in user ability, the timeout period T_{D} can vary, but generally the timeout period T_{D} is in a range of about 200 milliseconds to about 1000 milliseconds. If the SHIFT key is pressed again during the timeout period T_{D}, the processor 102 goes back to step 214 and again asks whether the key compression pattern now includes five consecutive SHIFT key presses. If a letter key, e.g., “A,” “B,” “C,” etc., is pressed during the timeout period T_{D} or the timeout period T_{D} has elapsed, the processor 102 then asks whether the compression pattern includes two “fast” SHIFT key presses, i.e., the second press of the SHIFT key occurred consecutively after the first and within the timeout period T_{D} after the first release of the SHIFT key (step 220). If so, the processor 102 activates the Caps-Lock function and all letter keys subsequently pressed will appear as capital letters (step 222).

By following the method of FIG. 4, the processor 102 will activate the sticky keys function any time the SHIFT key is pressed five consecutive times, regardless of the amount of time that passes between presses, so long as the compression pattern does not include two fast SHIFT key presses followed by a pause that is longer than the timeout period T_{D} or compression of a letter key. In this way, the method can accommodate users who lack the manual dexterity to press a key five times in a row quickly, or even at the same pace. Furthermore, it is robust in situations where a user accidentally presses the SHIFT key more than twice when intending to activate the Caps-Lock function. For example, where a user accidentally presses the SHIFT key three or four times instead of two, so long as two of the presses were fast and followed by a pause greater than the timeout period T_{D} or by a letter key, the Caps-Lock function will be activated.

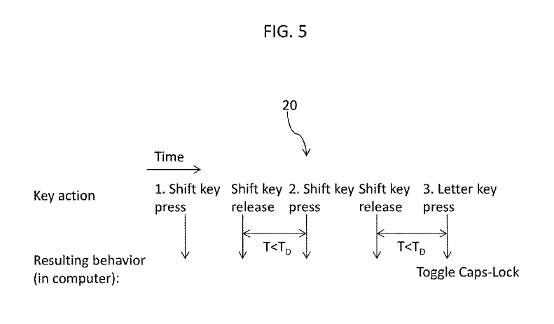

Three exemplary compression patterns that meet the criteria for activating the Caps-Lock function, according to the method 208, are illustrated in FIGS. 5-8. FIG. 5 illustrates a compression pattern 20 that includes two SHIFT key presses, with the second SHIFT key press occurring within the timeout period T_{D} after the first release of the SHIFT key. The second SHIFT key release is followed by compression of a letter key, also within the timeout period T_{D} after the second SHIFT key release. Because there have been two fast SHIFT key presses followed by a letter key press (steps 218, 220), the processor 102 will activate the Caps-Lock function (step 222) in this case immediately after the letter key has been pressed.

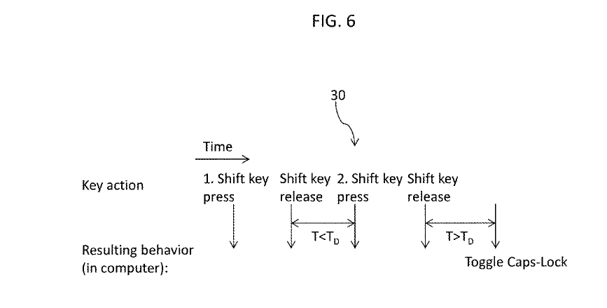

A second exemplary compression pattern 30 that meets the criteria for triggering the Caps-Lock function, according to the method 208, is illustrated in FIG. 6. This compression pattern also includes two SHIFT key presses, with the second SHIFT key press occurring within the timeout period T_{D} after the first release of the SHIFT key. Here, however, the second release of the SHIFT key is followed by a period of inactivity that is greater than the timeout period T_{D}. Because there have been two fast SHIFT key presses followed by a period of inactivity that is greater than the timeout period T_{D} (steps 218, 220), the processor 102 will trigger the Caps-Lock function (step 222) in this case. Notably, the Caps-Lock function will not be activated until the timeout period T_{D} has elapsed after the final SHIFT key release.

A third exemplary compression pattern 40 that meets the criteria for activating the Caps-Lock function, according to the method 208, is illustrated in FIG. 7. Here, the SHIFT key has been pressed four times consecutively, with various time periods elapsing between the four releases and subsequent presses. Nonetheless, because the compression pattern 30 from FIG. 6 is contained within the compression pattern 40 (as highlighted by the grey box), the compression pattern 40 will also activate the Caps-Lock function (222) once the timeout period T_{D} has elapsed after the final SHIFT key release.

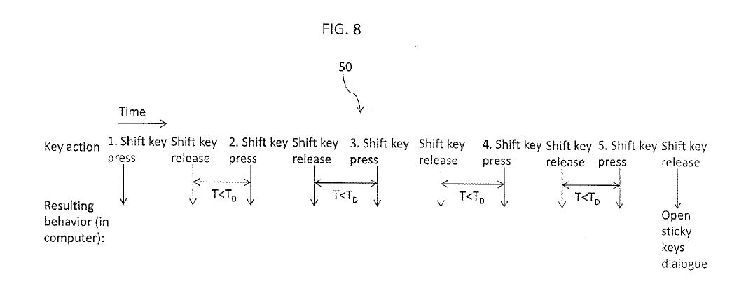

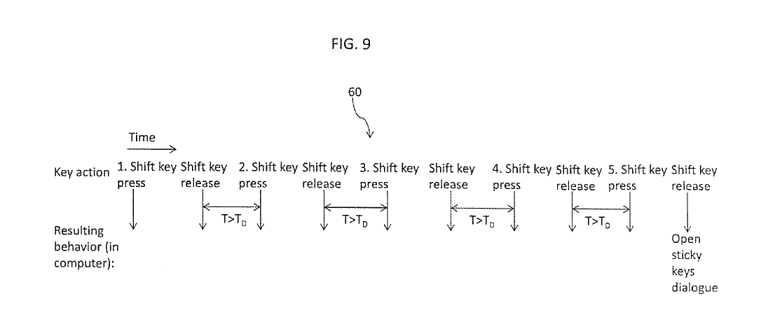

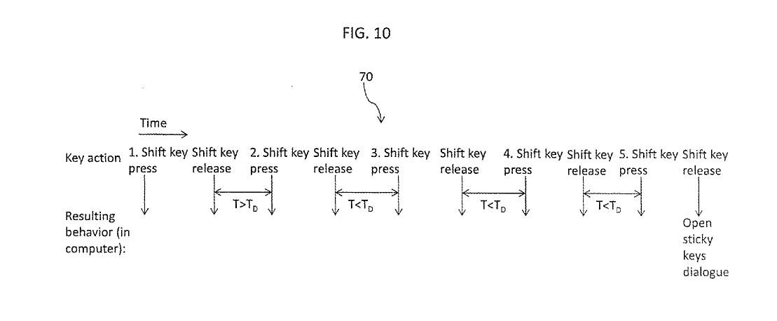

Three exemplary compression patterns that meet the criteria for bringing up the sticky keys dialogue, according to the method 208, are illustrated in FIGS. 8-10. FIG. 8 illustrates an exemplary compression pattern 50 that includes five “fast” consecutive presses of the SHIFT key, with each press occurring within the timeout period T_{D} after the previous release. FIG. 9 illustrates an exemplary compression pattern 60 that includes five “slow” consecutive presses of the SHIFT key, with each press occurring outside of the timeout period T_{D} after the previous release. FIG. 10 illustrates an exemplary compression pattern 70 that includes two “slow” consecutive presses of the SHIFT key followed by three “fast” presses of the SHIFT key. Because all of the compression patterns 50, 60, 70 include five consecutive SHIFT key presses (step 214), and because none of the patterns 50, 60, 70 includes two fast SHIFT key presses followed by a pause greater than the timeout period T_{D} or a letter key press (steps 218, 220), they will all cause the processor 102 to bring up a dialogue box on a computer display asking whether the user wants to activate the sticky keys function (step 216). Notably, the processor 102 brings up the dialogue box immediately after the final SHIFT key release, without waiting for the timeout period T_{D} to elapse.

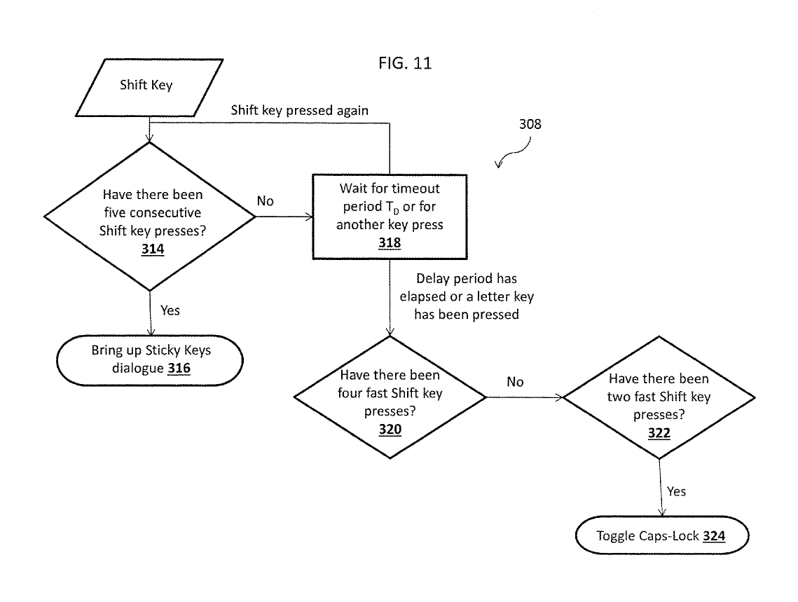

A second embodiment of a method 308 for analyzing key compression patterns, also triggered when a user compresses and releases the SHIFT key, is illustrated in FIG. 11. Steps 314, 316, 318, and 322 are analogous to steps 214, 216, 218, and 220, respectively, of the first embodiment. Here, however, after the timeout period T_{D} has elapsed and/or a letter key has been pressed (step 318), the processor 102 asks whether there have been four “fast” SHIFT key presses, i.e., the last three presses occurring within the timeout period T_{D} after the previous release. Only if the answer to this question is no will the processor 102 go on to step 322 and potentially activate the Caps-Lock function at step 324. The determination at step 320 is based on the assumption that if a user quickly pressed the SHIFT key four times in a row, they likely intended to “undo” the first double press with the second double press. Thus, it would not be appropriate to activate the Caps-Lock function.

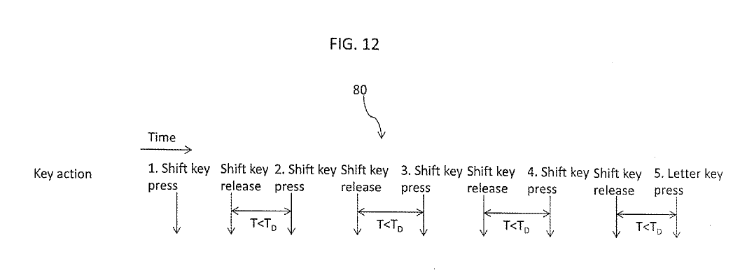

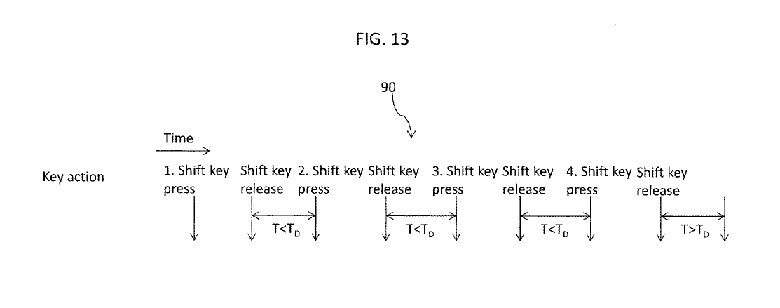

Applying the second embodiment of the method 308 to the key compression patterns of FIGS. 6-10 would yield the same results as the first method 208. However, the methods 208 and 308 will result in different computer behavior based on the exemplary key compression patterns 80 and 90 illustrated in FIGS. 12 and 13, respectively. Both key compression patterns 80, 90 include four “fast” SHIFT key presses. In the key compression pattern 80, a letter key is pressed within the timeout period T_{D} following the final release of the SHIFT key, whereas in the key compression pattern 90, there is a period of inactivity that is greater than the timeout period T_{D} after the final release of the SHIFT key. Because the key compression patterns 80, 90 do not include five consecutive SHIFT key presses (step 214), but do include two fast SHIFT presses followed by a period of inactivity that is greater than the timeout period T_{D} (steps 218, 220), the processor 102 following the method 208 of FIG. 4 will activate the Caps-Lock function (step 222). However, applying the method 308 of FIG. 11, the processor 102 will not activate the Caps-Lock function based on the compression patterns 80, 90. After determining that there have not been five consecutive SHIFT key presses (step 314) and determining that there have been four fast SHIFT presses (step 320), method 308 simply terminates and waits for the next keyboard input.

Although the invention has been described by reference to specific embodiments, a person skilled in the art will understand that numerous changes may be made within the spirit and scope of the inventive concepts described. A person skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

What is claimed is:

1. A method comprising:
retrieving, by at least one computer processor, a key compression pattern that comprises identities of one or more keys that have been pressed by a user and time intervals between each key press and a previous key release;
determining, by the at least one computer processor, whether the key compression pattern includes five consecutive presses of a key;
if the at least one computer processor determines that the key compression pattern includes five consecutive presses of the key, sending a first signal immediately after the fifth release of the key; and
if the at least one computer processor determines that the key compression pattern does not include five consecutive presses of the key, waiting for a timeout period before determining whether to send a second signal.

2. The method of claim 1, further comprising sending the second signal when the at least one computer processor determines that the key compression pattern includes two consecutive presses of the key, with a second press occurring within a timeout period after a first release, and the second press being followed by a period of inactivity that is greater than the timeout period or by pressing a different key.

3. The method of claim 1, wherein the first signal comprises a signal to generate a prompt on a computer display asking the user whether they would like to activate a first keyboard function.

4. The method of claim 1, wherein the second signal comprises a signal to activate a second keyboard function.

5. The method of claim 1, wherein the key is the shift key, the first signal comprises a signal to generate a prompt on a computer display asking the user whether they would like to activate a sticky keys function, and the second signal comprises a signal to activate the Caps-Lock function.

6. A method, comprising:
for a plurality of keyboard functions, storing one or more criteria in a data store for activating the keyboard function, the one or more criteria being met by at least two different key compression patterns;
after a release of a final key in an input key compression pattern, retrieving the input key compression pattern by at least one computer processor and sequentially determining whether the input key compression pattern meets the one or more criteria for each of the plurality of keyboard functions in turn; and
between at least two of the sequential determinations, waiting for a timeout period.

7. The method of claim 6, wherein at least one of the at least two key compression patterns is based on an assumption about user inability to create the other of the at least two key compression patterns.

8. The method of claim 6, wherein the at least one computer processor first determines whether the input key compression pattern meets the one or more criteria for a first keyboard function, and then determines whether the input key compression pattern meets the one or more criteria for a second keyboard function, the one or more criteria for the first keyboard function being met by a key compression pattern that is longer than a key compression pattern that meets the one or more criteria for the second keyboard function.

9. The method of claim 6, wherein at least one of the at least two different key compression patterns for each of the plurality of keyboard functions includes consecutive presses of a single key.

10. A method comprising:
retrieving, by at least one computer processor, a key compression pattern that comprises identities of one or more keys that have been pressed by a user and time intervals each key press and a previous release; and
determining, by the at least one computer processor, whether they key compression pattern meets one or more criteria for activating a first keyboard function;
if the at least one computer processor determines that the key compression pattern meets the one or more criteria for activating the first keyboard function, prompting the user on a computer display about activating the first keyboard function; and
if the at least one computer processor determines that the key compression pattern does not meet the one or more criteria for activating the first keyboard function, waiting for a timeout period before determining whether the key compression pattern meets one or more criteria for activating a second keyboard function.

11. The method of claim 10, further comprising activating the second keyboard function when the at least one computer processor determines that the key compression pattern meets one or more criteria for activating the second keyboard function.

12. The method of claim 10, wherein the one or more criteria for activating the first keyboard function comprises at least two different key compression patterns, each of the different key compression patterns including multiple presses of a single key.

13. The method of claim 10, wherein the one or more criteria for activating the second keyboard function includes at least two different key compression patterns, each of the different key compression patterns including at least two presses of a single key, with a second press occurring within the timeout period after a first release.

14. The method of claim 10, wherein the first keyboard function is the sticky keys function and the second keyboard function is the Caps-Lock function.

15. A computer system, comprising:
a keyboard having a plurality of keys;
a memory configured to store one or more criteria for activating each of a plurality of functions of the keyboard, the one or more criteria being met by at least two different key compression patterns;
at least one computer processor configured to sequentially determine whether an input key compression pattern meets the one or more criteria for each of the plurality of keyboard functions in turn, and, between at least two of the sequential determinations, to wait for a timeout period.

16. The system of claim 15, wherein the memory is housed within the keyboard.

17. The system of claim 15, wherein the at least one computer processor is housed within the keyboard.

18. A non-transitory computer-readable storage medium containing instructions, wherein the instructions cause one or more computer processors to:
retrieve a key compression pattern that comprises identities of one or more keys that have been pressed by a user and time intervals between each key press and a previous key release;
determine whether the key compression pattern includes five consecutive presses of a key;
if the one or more computer processors determine that the key compression pattern includes five consecutive presses of the key, send a first signal immediately after the fifth release of the key; and
if the one or more computer processors determine that the key compression pattern does not include five consecutive presses of the key, wait for a timeout period before determining whether to send a second signal.
